(19) United States
(12) Patent Application Publication
(10) Pub. No.: US 2013/0339939 A1
(43) Pub. Date: Dec. 19, 2013

(54) INFORMATION PROCESSING APPARATUS, CONTROL METHOD THEREOF, AND STORAGE MEDIUM

(71) Applicant: CANON KABUSHIKI KAISHA, Tokyo (JP)

(72) Inventor: AKIRA ISHIKAWA, Machida-shi (JP)

(21) Appl. No.: 13/912,938

(22) Filed: Jun. 7, 2013

(30) Foreign Application Priority Data
Jun. 19, 2012 (JP) 2012-138172

(51) Int. Cl. G06F 9/445

(52) U.S. Cl. CPC G06F 8/65
USPC 717/168

(57) ABSTRACT

An information processing apparatus determines whether or not only application is included in the object of an update of one or more software stored in a memory unit, and updates the software that is the object of the update. The information processing apparatus does not reboot when only application is included in the software that is the object of the update. When software other than application is included in the software that is the object of the update, the information processing apparatus reboots with an initialization of the hardware when the kernel is included in the software that is the object of the update, and reboot without the initialization of the hardware when the kernel is not included in the software that is the object of the update.

### BACKGROUND OF THE INVENTION

1. Field of the Invention

The present invention relates to an information processing apparatus, a control method thereof, and a storage medium.

2. Description of the Related Art

Similar to general-use PCs, recent multi-purpose devices implement function additions and patches by periodically updating software even after being placed on the market. Broadly categorized, software is configured by an application part having a high independence and an OS part that is dependent on the system overall. In the case where software for an application is updated, because the independence is high, the object program file is updated, and the update is complete when the object application alone is reactivated (below, referred to as a “reboot” or “reboot processing”). Because OS software is dependent on the system overall, rebooting only the updated OS software is not possible. Thus, when OS software is updated, the entire system must be rebooted after the file that is the object of the update has been replaced by the program file used for updating. Because this reboot processing takes time in comparison to rebooting a single application, downtime occurs, and the user must wait until the system has completed the reboot. In an update distribution for a general-use PC, it is determined whether or not OS software that is an object of the update is included, and by rebooting only in the case where OS software is included, unnecessary downtime for rebooting for updating an application is not incurred.

Also, in the case where OS software is updated, the update processing itself is also implemented by the OS, but because the object of the update and the executor of the update are the same, inconsistencies in the program files will occur during the updating process, and the system will not be able to implement the update processing. Thus, conventionally two OS portions are present in a device, and a means is provided whereby one updates the other. Japanese Patent Laid-Open No. H11-7382 discloses a system in which firmware used for an update is stored in a non-operational memory area, the firmware that is the object of the update is executed simultaneously in parallel in operational memory area, and firmware is switched to firmware for updating is at a timing in synchronization with both firmware.

By being provided with two OSs, inconsistencies in the program files in the updating process can be avoided, but reboot processing that reactivates the entire system is necessary in the case where the OS software is updated, and generally this is accompanied by the power source being cut off. However, an initialization of hardware due to the reboot processing is not necessarily required. Specifically, in an OS, during the updating of a Kernel in which hardware control software is included, the initialization of the system overall is necessary. In an OS, during the updating of software other than a Kernel that is not included in hardware control software, the initialization of the entire system is not necessary. Conventionally, when updating OS software, the updating process consumes time because the initialization of the entire system is carried out irrespective of whether a Kernel is the object, that is, the initialization is carried out with a power cutoff.

### SUMMARY OF THE INVENTION

In the update processing of software, the information processing apparatus of the present invention reduces the updating process time by rebooting without initializing an entire system in the case where a Kernel is not included in software that is the object of the update.

The information processing apparatus of an embodiment of the present invention is an information processing apparatus that updates software. The information processing apparatus includes a determination unit configured to determine whether or not only application is included in the objects of an update of the one or more software stored in a memory unit; an update unit configured to update one or more software that are the objects of the update; and a reboot unit configured not to reboot when only application is included in the one or more software that are the objects of the update, to reboot with an initialization of hardware when software other than the application is included in the one or more software that are the objects of the update and when a kernel is included in the one or more software that are the objects of the update, and to reboot without the initialization of the hardware when the kernel is not included in the one or more software that are the objects of an update.

Further features of the present invention will become apparent from the following description of exemplary examples with reference to the attached drawings.

### BRIEF DESCRIPTION OF THE DRAWINGS

FIG. 1 shows an example of a configuration of an image forming apparatus of the present invention.

FIG. 2 is a drawing of the internal configuration of the image forming apparatus.

FIG. 3 is a block diagram that shows the details of the controller unit of the image forming apparatus.

FIG. 4 illustrates a view of the configuration of data that is distributed on the Flash of the image forming apparatus.

FIG. 5 illustrates a flowchart in which the updating in first embodiment is implemented.

FIG. 6 is a diagram of data structure that is distributed on the Flash of the image forming apparatus.

FIG. 7 is a flowchart in which the updating in second embodiment is implemented.

### DESCRIPTION OF THE EMBODIMENTS

### First Embodiment

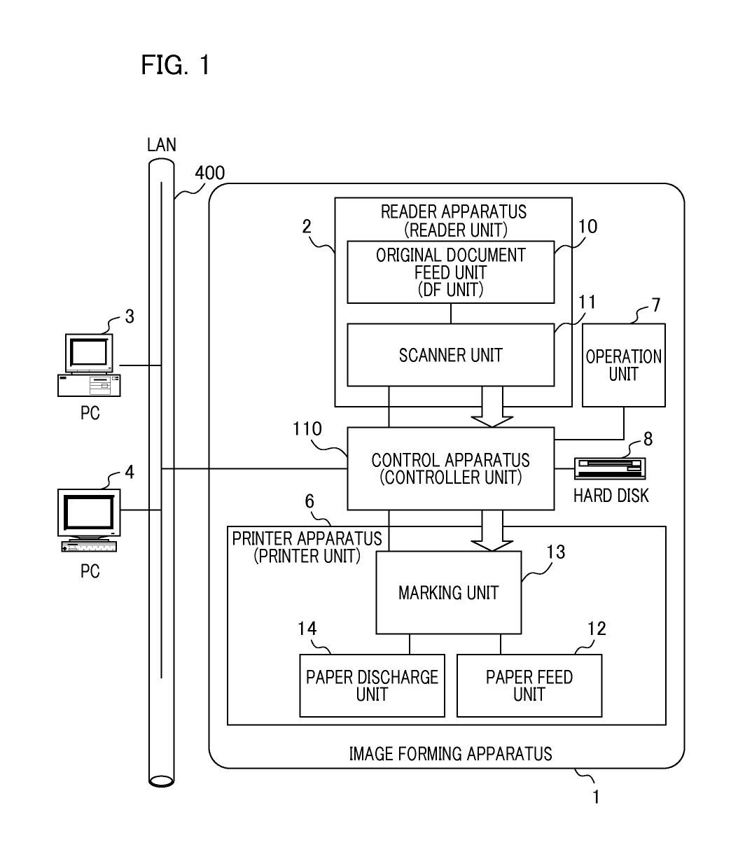

FIG. 1 illustrates an example of the configuration of an image forming apparatus that functions as the information processing apparatus of the present example. The image forming apparatus is explained as an example in the present example, but the present invention is a technology that can be applied to all computer systems. The image forming apparatus 1 is connected to a host computer (in the present embodiment, PC 3 and PC 4) via a LAN (Local Area Network) 400 such as an Ethernet (Registered Trademark) and the like.

The image forming apparatus 1 includes a reader unit 2, a printer unit 6, an operation unit 7, a controller unit 110, and a hard disk 8. The reader unit 2 carries out reading processing of image data. The printer unit 6 carries out input-output processing for the image data. The operation unit 7 executes processing according to the operation by a user. For example, the operation unit 7 is provided with a liquid crystal panel for carrying out display processing for image data and various types of functions. The controller unit 110 controls the image forming apparatus overall by providing instructions to each of the processing units provided in the image forming apparatus 1.

The reader unit 2 comprises an original document sheet feeding unit 10 and a scanner unit 11. The original document sheet feeding unit 10 conveys original document sheets. The scanner unit 11 optically reads the conveyed original document sheets and converts this to image data consisting of electric signals.

The printer unit 6 includes a paper feeding unit 12, a marking unit 13, and a paper discharge unit 14. The paper feeding unit 12 accommodates copier paper. In order to do this, the paper feeding unit 12 includes a multistage paper feeding cassette. The marking unit 13 transfers and fixes the image and the like to the copier paper. The paper discharge unit 14 implements sorting processing and staple processing on the printed copier paper, and discharges it to the outside. The control programs and image data and the like are written in advance to the hard disk 8.

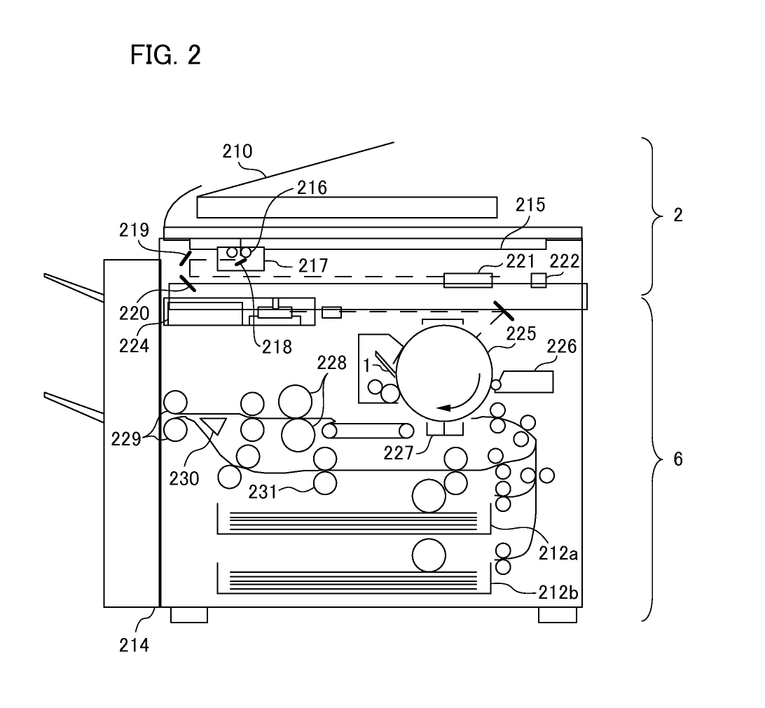

FIG. 2 is the internal configuration, which shows the details of the reader unit 2 and the printer unit 6 that are provided in the image forming apparatus shown in FIG. 1, and the reader unit 2 is mounted on the printer unit 6. In the reader unit 2, the original document sheets that are stacked in the original document sheet feeding unit 210 are fed one sheet at a time in sequence from the top onto a platen glass 215 according to the stacking order. After the scanner unit 11 has completed predetermined reading actions, the original document sheets that have been read are discharged from the platen glass 215 to the original document sheet discharge unit 14. In addition, at the scanner unit 11, a lamp 216 flashes when an original document sheet has been conveyed onto the platen glass 215, and next the optical unit 217 starts moving. At this time, the original document sheet is fixed at the reading position. The optical unit 217 illuminates the original document sheet that has been fixed at the reading position from below, and scans the original document sheet. The reflected light from the original document sheet is guided to a CCD image sensor (below, simply referred to as a “CCD”) 222 via a plurality of mirrors 218 to 220 and a lens 221, and the original document image that has been scanned is read by the CCD 222. In addition, the image data that has been read by the CCD 222 is transferred to the controller unit 110 (not illustrated in FIG. 2) after predetermined processing has been applied.

As an alternative method, the lamp 216 flashes at the point in time that the original document sheet has been mounted on the platen glass 215, and next, the movement of the optical unit 217 starts, the original document sheet is illuminated from below, and scanned. Thereby, the original document image that has been scanned can also be read by the CCD 222. The image data from the reader that has been sent in the above sequence is transmitted to the controller unit 110 via a scanner connector 56.

Next, in the printer unit 6, a laser light emitting unit 224, which is driven by a laser driver 23 (not illustrated), emits a laser light corresponding to the image data that has been output from the controller unit 110. An electrostatic latent image is formed by the laser light on a light sensitive drum 225 of the marking unit 13. A developing device 226 adheres developing agent to the portion of the electrostatic latent image that has been formed.

At the same time, at a timing that has been synchronized with the start of the illumination of the laser light, the paper feeding unit 12 (paper feed cassettes 212a and 212b) supplies the copier paper and the copier paper is conveyed to the transfer unit 227. The transfer unit 227 transfers the developing agent adhered to the photosensitive drum 225 to the copier paper that has been fed. The copier paper to which the image data has been transferred is conveyed to the fixing unit 228, and the fixing unit 228 fixes the image data to the copier paper by heat and pressure processing. In the case where the image data is recorded on one side of the copier paper, the discharge rollers 229 directly discharge the copier paper that has passed through the fixing unit 228 to the paper discharge unit 14.

The paper discharge unit 14 sorts the copier paper by bundling the discharged copier paper. In addition, the paper discharge unit 14 carries out staple processing on the sorted copier paper. Additionally, in the case where the image data is recorded on both sides of the copier paper, the paper discharge unit 14 reverses the rotation direction of the discharge rollers 229 after the copier paper has been conveyed up to the discharge roller 229. Subsequently, the copier paper is guided to the paper re-supply conveying path by a flapper 230, and the copier paper is conveyed to the transfer unit 227 in the same manner that has been described above. The controller unit 110 is configured by a single electronic component, as has been described above. The controller unit 110 includes a scanner function that converts image data that has been read by the reader 2 to code, and transmits the code to first and second host computers 3 and 4 via a LAN 400. Furthermore, the controller unit 110 includes a printer function that converts code data that has been received from the host computers 3 and 4 via the LAN 400 to image data, and outputs the image data to a printer 6. The above described functions are examples, and the controller unit may include functions other than these.

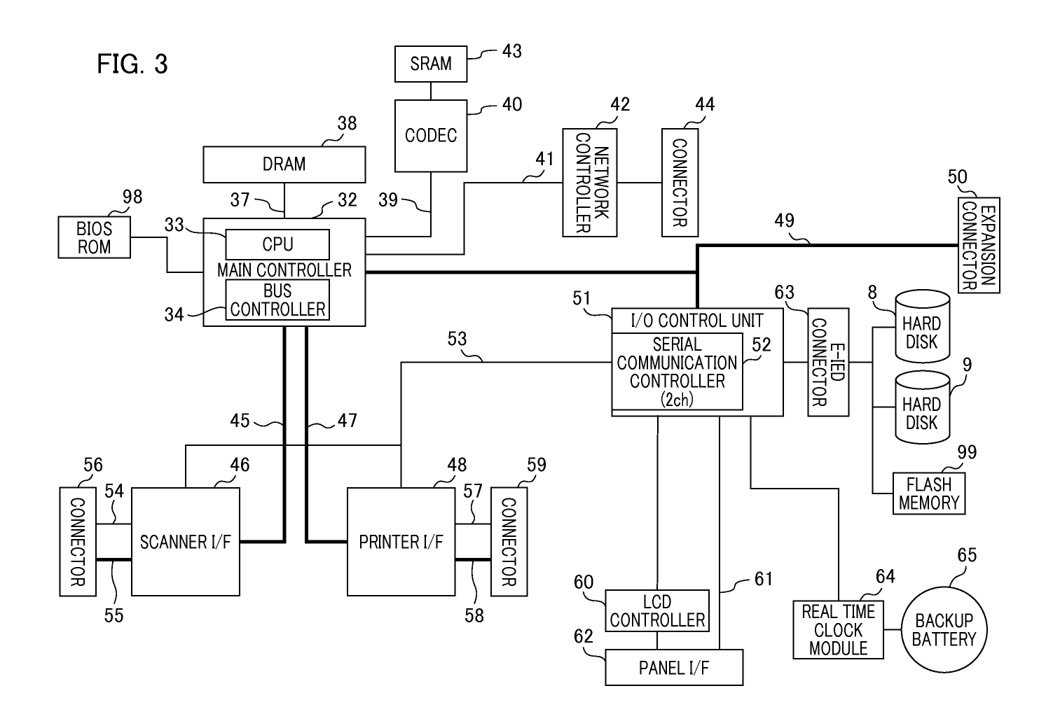

FIG. 3 is a diagram that shows an example of the configuration of a controller unit that is provided in the image formation unit that is shown in FIG. 1. Among the structural elements that are provided in the controller unit 110, a main controller 32 includes a CPU 33, a bus controller 34, and a function block that includes various types of controller circuits that will be explained below. The control method of the image forming apparatus of the present embodiment is realized by the CPU 33 executing computer programs that have been stored in a flash memory 99.

The main controller 32 is connected to the DRAM 38 via a DRAM I/F 37. The main controller 32 is also connected to a codec 40 via a codec I/F 39. The main controller 32 is also connected to a network controller 32 via a network I/F 41. The main controller 32 is also connected to a scanner I/F 46 via a scanner bus 45. The main controller 32 is also connected to a printer I/F 48 via a printer bus 47. The main controller 32 is also connected to an expansion connector 50 and an input-output control unit (I/O control unit) 51 for connecting the expansion board via a general-use high speed bus 49, such as a PCI bus and the like.

The DRAM 38 is used as an operation area for the CPU 33 to carry out activity and as an area for accumulating image data. The codec 40 compresses raster image data that has been accumulated in the DRAM 38 by a well-known compression format such as MH, MR, MMR, and JBIG and the like. In addition, the codec 40 expands the compressed raster data to a raster image. In addition, SRAM 43 is connected to the codec 40, and SRAM 43 is used as a temporary operation area for the codec 40.

The network controller 42 carries out a predetermined control operation with the LAN 400 (FIG. 2) via a network connector 44. The I/O control unit 51 transmits and receives control commands between the reader unit 2 and the printer unit 6 shown in FIG. 2. In the I/O control unit 51, an asynchronous serial communication controller 52 for transmitting and receiving the above control commands is equipped with two channels. The serial communication controller 52 is connected to the scanner I/F 46 and the printer I/F 48 via the I/O 53 bus.

The scanner I/F 46 is connected to the scanner connector 56 via a first asynchronous serial I/F 54 and a first video I/F 55. In addition, the scanner connector 56 is connected to the scanner unit 11 of the reader unit 2. In addition, the scanner I/F 46 carries out desired binarization processing and magnification processing in the horizontal scan direction and the vertical scan direction on the image data that has been received from the scanner unit 11. In addition, the scanner I/F 46 generates control signals based on a video signal that has been sent from the scanner unit 11, and transfers the control signals to the main controller 32 via the scanner bus 45.

In addition, the printer I/F 48 is connected to the printer connector 59 via a second asynchronous serial I/F 57 and a second video I/F 58. In addition, the printer connector 59 is connected to the marking unit 13 of the printer unit 6. In addition, the printer I/F 48 implements a smoothing process on image data that has been output from the main controller 32, and the image data is output to the marking unit 13. In addition, the printer I/F 48 outputs the control signals generated based on the video signal that has been sent from the marking unit 13 to the printer bus 47. The printer I/F 48, for example, interprets the PDL (Page Description Language) data that has been received from the host computer that is connected by the LAN 400, and converts this data into raster image data.

In addition, the bus controller 34 controls the data transfer of data that is input to and output from external devices that are connected to the scanner I/F 46, the printer I/F 48, the other expansion connector 50 and the like. Specifically, the bus controller 34 carries out arbitration of usage rights and the transfer of DMA data. For example, the above-described data transfer between the DRAM 38 and the codec 40, the data transfer from the scanner unit 11 to the DRAM 38, and the data transfer from the DRAM 38 to the marking unit 13 and the like are controlled by the bus controller 34 and DMA transfer is carried out.

In addition, the I/O control unit 51 is connected to a panel I/F 62 via an LCD controller 60 and a key input I/F 61. The panel I/F 62 is connected to the operation unit 7. In addition, the I/O control unit 51 is connected to the hard disks 8 and 9 and the flash memory 99 via an E-IDE connector 63.

The flash memory 99 stores various types of control programs for main controller control and various types of data in memory areas. In addition, the flash memory 99 is connected to a real time clock module 64 that updates and stores a date and time that are managed in the devices. The real time clock module 64 is connected to a back-up battery 65 and is backed up by the back-up battery 65. The BIOS ROM 98 is connected to the main controller 32, and stores IO initialization programs.

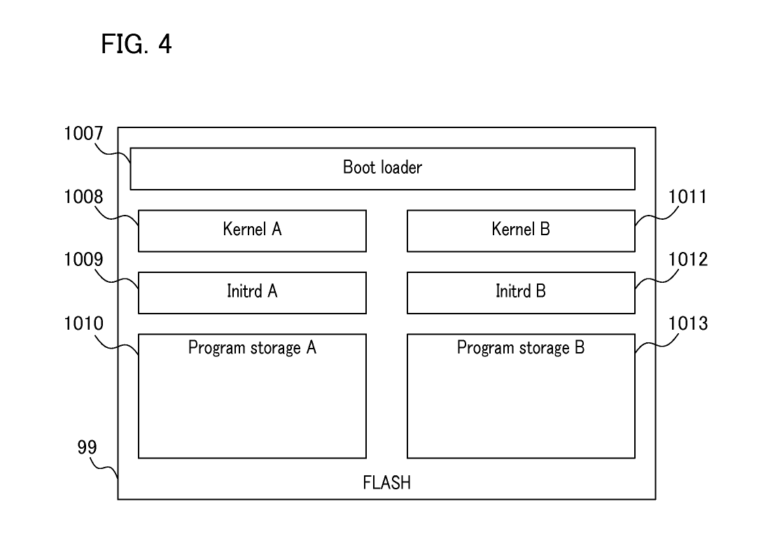

Next, referring to FIG. 3 and FIG. 4, the configuration of the one or more software that are distributed on the flash memory 99 will be explained. The flash memory 99 functions as a memory unit, and includes, internally as software, a boot loader 1007, a kernel A 1008, an initrd A 1009, and a program storage 1010. Furthermore, the flash memory 99 includes a kernel B 1011, an initrd B 1012, and a program storage B 1013.

The boot loader 1007 is executed after being loaded into the DRAM 38 by the BIOS 98, and the kernel A 1008, the initrd A 1009, the kernel B 1011, and the initrd B 1012 are loaded into the DRAM 38.

After the initrd A 1009 and the initrd B 1012 have been loaded into the DRAM 38, the DRAM 38 is used as a temporary activation the disk during Kernel initialization. The kernel A 1008 and the kernel B 1011 respectively activate the initrd A 1009 and the initrd B 1012 as temporarily activation disks. Subsequently, the kernel A 1008 and the kernel B 1011 respectively install program storage A 1010 and program storage B 1013 as actual activation disks. The program storage A 1010 and the program storage B 1013 respectively store software that include an application portion and an OS portion. After the kernel A 1008 or the kernel B 1011 have installed program storage A 1010 and program storage B 1013, the function of a copier is executed by activating software that has been distributed internally.

In the present embodiment, the CPU 33 does not execute after developing all programs on the DRAM 38 that is used as an operating unit, but selects only necessary programs on demand by using a demand loading mechanism, and necessary the programs are loaded into the DRAM 38. The kernel A 1008, the initrd A 1009, the program storage A 1010, the kernel B 1011, the initrd B 1012, and the program storage 1013 are redundantly configured in order to implement software updates. One updates the other, and thereby, inconsistencies during the update processing are avoided, and recovery processing during an update failure becomes possible. The kernel A 1008 and the initrd A 1009, and the kernel B 1011 and the initrd B 1012 are each used in combination. The program storage A 1010 and the program storage B 1013 are used in arbitrary combination with the kernel A 1008 and the kernel B 1011 according to the sequence of the updating processing.

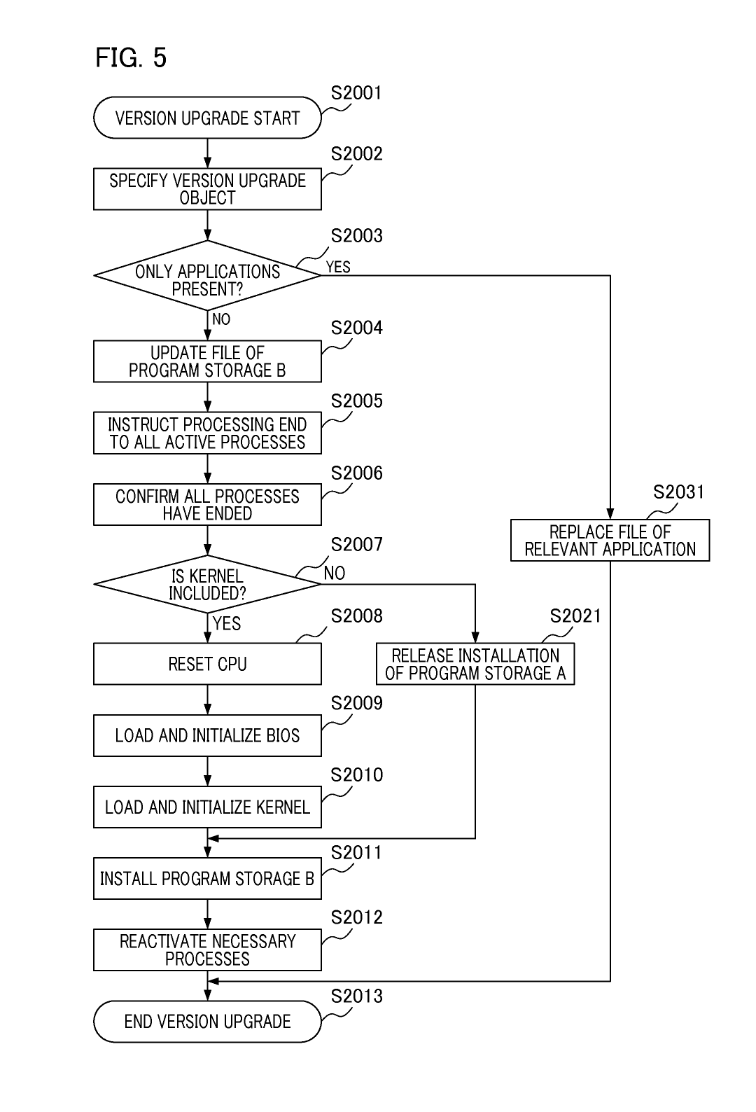

Next, FIG. 5 is a diagram that explains updating the version of the software for the image forming apparatus. The flowchart that is shown in FIG. 5 is realized by the CPU 33 of the main controller 32 by executing according to the programs that have been stored in the flash memory 99. In step 2001, software of the main controller 32, which is distributed on the program storage A 1010 and activated, initiates the updating of the version upon receipt of a user instruction. The software used in step 2001 are the kernel A 1008, the initrd A 1009, and the program storage A 1010.

In step 2002, the CPU 33 produces a list of software for which instructions have been provided for version updating. In step 2003, the CPU 33 refers to metadata included in each of the software to confirm whether software other than the application software is included in the software list that was produced in step 2002. In other words, the CPU 33 functions as a determination unit that determines whether only applications are included in objects of the update of the software. In step 2003, in the case where software other than the application software has not been detected, the CPU 33 implements the processing of step 2031.

In step S2031, the CPU 33 functions as an update unit, and substitutes the program file corresponding to the application that is the object of the update in the program storage A 1010 to thereby implement updating. In addition, in step 2013, the CPU 33 ends the version updating. Because applications are not dependent on other processes and have a high independence, the CPU 33 can update the applications by a simple process in this manner. In addition, only software having such high independence includes information as metadata that shows that the software is an application. Because a reboot process takes from several tens of seconds to minutes, even without an initialization of hardware, updating only the applications can be implemented at the highest speed.

In step 2003, the CPU 33 executes the processing of step 2004 in the case where software other than applications has been detected. In step 2004, the CPU 33 implements updating by replacing the program files corresponding to one or more OS software that are the objects of the update after copying the content of the program storage A to the program storage B. Thereby, the occurrence of inconsistencies in the program files during the updating process can be prevented. In the case where software for a kernel and an initrd are included as objects of the update, after updating the kernel A 1008 and the initrd A 1009, they are respectively copied to kernel B 1011 and the initrd B 1012, and the processing of step 2005 is executed.

In step 2005, the CPU 33 instructs an end processing for all processes related to the programs that are activated and being executed in the system. Each of the processes receives instructions from the CPU 33, implements processes that have not been ended such as the writing of data and the like, ends the execution of the processes. In this manner, what is required to end the processing of the system overall is that the logic of the OS affect all of the process, and thus, each process cannot reopen processing in a state in which consistency between processes is maintained simply by partially reactivating the software for the OS. The CPU 33 implements the processing of step 2007 when the end of all the processes can be confirmed in step 2006.

In step 2007, the CPU 33 confirms whether the software for the kernel and the initrd is included in the software list that was produced in step 2002. The CPU 33 implements the processing of step 2008 in the case where it confirms in step 2007 that the software for the kernel and the initrd is included. In step 2008, by resetting the CPU 33, the CPU is transitioned to the initial state when the electric power is turned on, and the processing of step 2009 is implemented. Specifically, in the case where the CPU 33 determines that the kernel is included in the software that is the object of the update in step 2007, the CPU 33 executes a reboot that requires an electric power cutoff (the power of the image forming apparatus 1 is turned OFF and subsequently, the electric power is turned ON).

In step 2009, the CPU 33 loads the BIOS ROM 98 into the DRAM 38 and starts the initialization of the BIOS. By initializing the BIOS, the CPU 33 implements the initialization of software of the portions that mainly relate to the IO devices, and subsequently, implements the processing of step 2010. In step 2010, the CPU 33 loads the kernel B 1011 and the initrd B 1012 into the DRAM 38, and starts the initialization of the kernel. Specifically, in the case where the kernel must be initialized, the CPU 33 maintains program storage A 1011. In initialize of the kernel, the CPU 33 executes the initialization of all hardware that is described as a device driver in the kernel, and after completion, implements the processing of step 2011.

In the case where the CPU 33 determines that the kernel is not included in step 2007, the CPU 33 implements the processing of step 2012. In step 2021, the CPU 33 releases the installation of the program storage A 1010, and implements the processing of step 2011. In the case where the kernel is not included, because initialization of hardware with an electricity cutoff is not necessary, the CPU 33 can realize updating simply by replacing the programs that correspond to the OS software. In other words, the CPU 33 switches from the program storage A 1010, in which the object of activation is installed by the kernel, to the program storage B 1013. After the update processing has completed, the content included in the program storage A 1010 may be deleted at an arbitrary timing. By the above described configuration, in the case where instructions for a version update have been provided after program storage B 1013 has been installed, the CPU 33 copies the program storage B 1013 to the program storage A 1010. Then the copied program storage A 1010 is updated. That is, in the case where the CPU 33 determines that a kernel is not included in software that is the object of the update in step 2007, the CPU 33 executes a reboot that is not required for an electric power cutoff.

In step 2011, the CPU 33 installs program storage B 1013 and implements the processing of step 2012. In step 2012, the CPU 33 activates the necessary processing groups in accordance with the activation sequence that has been planned in advance. For example, processes that are included in program storage B 1013, which correspond to the processes that are included in program storage A 1010 that were ended in step 2005, are reactivated. That is, the CPU 33 functions as a reboot unit that reboots according to the type of the software that is included in the software that is the object of the update. Specifically, the CPU 33 does not reboot in the case where the software that is the object of the update only includes applications. In the case where software other than applications is included in the software that is the object of the update, and in case where software that is the object of the update includes a kernel, the CPU 33 carries out initialization, and carries out rebooting without an initialization in the case where a kernel is not included. Then, in step 2013, the CPU 33 ends the version updating.

In step 2003, in the case where the CPU 33 determines that applications are not included, software that are used after updating the version are the kernel A 1008, the initrd A 1009, and the program storage A 1010. In the case where the CPU 33 determines that the kernel is not included in step 2007, software that are used after updating the version are the kernel A 1008, the initrd A 1009, and the program storage B 1013. In the case where the CPU determines that the kernels is included in step 2007, software that are used after updating the version are the kernel B 1011, the initrd B 1012, and program storage B 1013.

By the above processing, according to the information processing apparatus of the present invention, in the update processing of software, in the case where a kernel is not included in software that are the object of the update, update processing time is reduced by rebooting without initializing the entire system.

### Second Embodiment

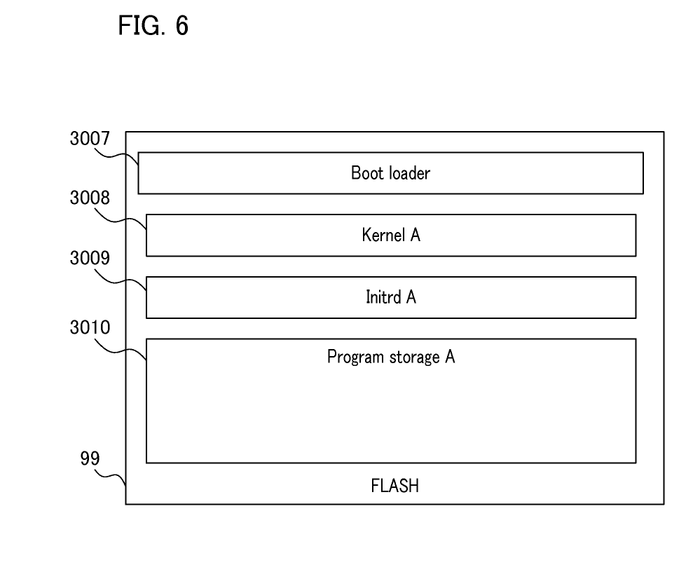

Next, an example will be explained for the case in which the CPU 33 does not load on demand programs that are distributed on the program storage A 1010 and program storage B 1013, and executes after loading all programs to the DRAM 38 during activation. With reference to FIG. 3 and FIG. 6, the configuration of software that are distributed on the flash memory 99 will be explained.

As shown in FIG. 6, the flash memory 99 internally includes a boot loader 3007, a kernel A 3008, an initrd A 3009, and a program storage A 3010. The CPU 33 loads the Boot loader 3007 into the DRAM 38 by using the BIOS 98, and next, the loaded boot loader 3007 loads the kernel A 3008 and the initrd A 3009 to the DRAM 38. After the initrd A 3009 has been loaded into the DRAM 38, it is used as a temporary activation disk during the kernel initialization. The kernel A 3008 activates the initrd A 3009 as a temporary activation disk. Subsequently, the CPU 33 loads all of the content of program storage A 3010 to the DRAM 38.

Thus, in the present embodiment, because on demand loading is not executed, the DRAM 38 having a larger capacity than the capacity of the program storage A 3010 is required. The program storage A 3010 stores applications and OS software. After loading the program storage A 3010, the function of a copier is executed by activating software that is distributed internally by the kernel A 3008. When the activation process has completed, program storage A 3010 cannot be accessed, and thus, the CPU 33 can rewrite the program storage A 2010 at an arbitrary timing during execution, and implement the version update.

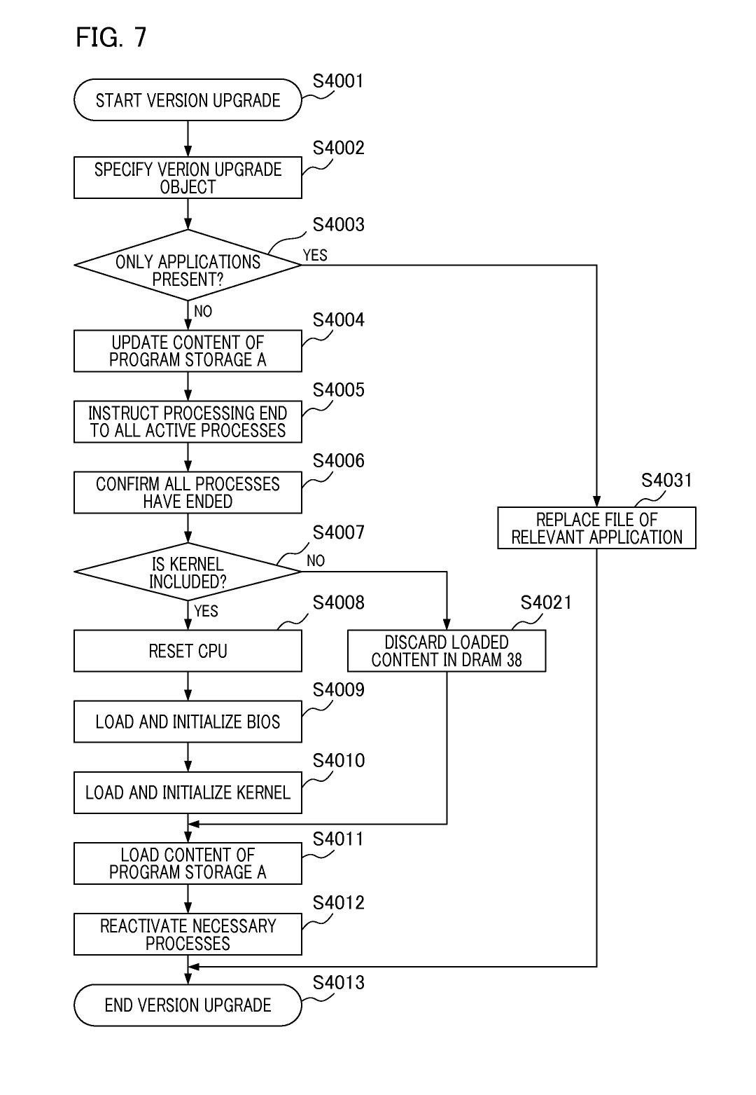

Next, with reference to FIG. 7, the flow of the version update implementation will be explained. The present flowchart is realized by the CPU 33 of the main controller 32 executing according to the programs that are stored in the flash memory 99.

In step 4001, the software of the main controller, which is distributed on the program storage A 3010 and activated, initiates the version updating upon receipt of an instruction from the user. In step 4002, the CPU 33 produces a list of software for which version updating instructions have been provided. In step 4003, the CPU 33 refers to metadata included in each of the software and confirms whether software other than application software is included in the software list that was produced in step 4002.

In step 4003, in the case where software other than application software is not detected, the CPU 33 implements the processing of step 4031. In step 4031, the CPU 33 replaces the program files corresponding to applications that are the objects of the update in the program storage A 3001 and in DRAM 38. Subsequently, the processing of step 4013 is implemented.

In the case where software other than applications is detected in step 4003, the CPU 33 implements the processing of step 4004. In step 4004, the CPU 33 implements updating by replacing program files corresponding to OS software that is an object of the update on the program storage A 3010. Furthermore, in the case where a kernel and an initrd are included, the CPU 33 updates kernel A 3008 and the initrd A 3009, and implements the processing of step 4005.

In step 4005, the CPU 33 instructs an end processing for the programs in all processes related to programs that are activated and executed in the system. Each of the processes receives instructions from the CPU 33, implements processes that have not been ended such as the writing of data and the like, ends the execution of the processes. In step 4006, the processing of step 4007 is implemented when all processes are confirmed to have ended in step 4006. In step 4007, the CPU 33 confirms whether a kernel and the initrd are included in the software list that was produced in step 4002.

In step 4007, in the case where the CPU 33 confirms that the kernel and the initrd are included, the CPU 33 implements the processing of step 4008. In step 4008, by resetting the CPU 33, the CPU is transitioned to the initial state when the power is turned on, and the processing of step 4009 is implemented. In step 4009, the CPU 33 loads the BIOS ROM 98 into the DRAM 38, and starts the initialization of the BIOS. In the initialization of the BIOS, after the CPU 33 has executed the initialization of the hardware of the portions that mainly relate to IO devices, the CPU 33 implements the processing of step 4010. In step 4010, the CPU 33 loads the kernel A 3008 and the initrd A 3009 into the DRAM 38, and starts the initialization of the kernel. In the initialization of the kernel, after the CPU 33 has executed the initialization of all hardware that are described as device drivers in the kernel, the CPU 33 implements the processing of step 4011.

In step 4007, in the case where the CPU 33 determines that the kernel is not included, the CPU 33 implements the processing of step 4021. In step 4021, the CPU 33 prepares the reloading of the program storage A 3010, and deletes the content of the DRAM 38. In step 4011, the CPU 33 loads all the content of the program storage A 3010 into the DRAM 38, and implements the processing of step 4012. In step 4012, the CPU 33 activates the necessary process groups according to the activation sequence that planned in advance. Then, in step 4013, the CPU 33 ends the version updating.

By these processes, the capacity of the flash memory 99 can be decreased by increasing the capacity of the DRAM 38.

By carrying out the above control, in the case where only an application portion is present, only the replacement of files is implemented, in the case where the OS unit that does not include a kernel, a reload without an initialization of the hardware is implemented, and in the case where a kernel is included, a reboot is implemented with an initialization of the hardware. Thereby, the user does not need to wait unnecessary down time.

Aspects of the present invention can also be realized by a computer of a system or apparatus (or devices such as a CPU or MPU) that reads out and executes a program recorded on a memory device to perform the functions of the above-described examples, and by a method, the steps of which are performed by a computer of a system or apparatus by, for example, reading out and executing a program recorded on a memory device to perform the functions of the above-described examples. For this purpose, the program is provided to the computer for example via a network or from a recording medium of various types serving as the memory device (e.g., computer-readable medium).

While the present invention has been described with reference to exemplary examples, it is to be understood that the invention is not limited to the disclosed exemplary examples. The scope of the following claims is to be accorded the broadest interpretation so as to encompass all such modifications and equivalent structures and functions.

This application claims the benefit of Japanese Patent Application No. 2012-138172 filed Jun. 19, 2012, which is hereby incorporated by reference herein in its entirety.

What is claimed is:

1. An information processing apparatus that updates software, comprising:
a determination unit configured to determine whether or not only application is included in the objects of an update of the one or more software stored in a memory unit;
an update unit configured to update one or more software that are the objects of the update; and
a reboot unit configured not to reboot when only application is included in the one or more software that are the objects of the update, to reboot with an initialization of hardware when software other than the application is included in the one or more software that are the objects of the update and when a kernel is included in the one or more software that are the objects of the update, and to reboot without the initialization of the hardware when the kernel is not included in the one or more software that are the objects of the update.

2. The information processing apparatus according to claim 1, wherein the update unit configured to update the software stored in the update unit when only the application is included in the one or more software that are the objects of the update, and to update copied software after copying the software stored in the memory unit to other memory unit that differs from the memory unit when software other than the application is included in the one or more software that are the objects of the update, and
wherein, when the kernel is included in the objects of the update of the software, the reboot unit initializes the hardware while maintaining the software stored in the memory unit and are the objects of the update, installs, after the initialization, the software copied and updated to the other memory unit, and when the kernel is not included in the objects of the update of the software, the reboot unit switches an object to be activated by the kernel from the software stored in the memory unit and is the object of the update to the software copied and updated in the other memory unit.

3. The information processing apparatus according to claim 2, wherein the one or more software stored in the memory unit are loaded on demand and executed.

4. The information processing apparatus according to claim 1, further comprising an operation unit such that all software stored in the memory unit are loaded during execution of the update,
wherein the update unit updates the software loaded into the operation unit and the software stored in the memory unit when only application is included in the objects of the update of the software, and updates the software stored in the memory unit when the software other than the application is included in the one or more software that are the objects of the update, and
wherein the reboot unit initializes the hardware while maintaining the software loaded into the operation unit and installs the software stored in the memory unit after initialization when the kernel is included in the objects of the update of the software, and deletes the software loaded into the operation unit and installs the software stored in the memory unit when the kernel is not included in the objects of the update of the software.

5. The information processing apparatus according to claim 1, wherein the reboot with the initialization of the hardware carried out by the reboot unit is a reboot required for an electric power cutoff of the information processing apparatus, and the reboot without the initialization of the hardware carried out by the reboot unit is a reboot required for the electric power cutoff of the information processing apparatus.

6. A method for controlling an information processing apparatus that updates software, the method comprising:
determining whether or not only application is included in the objects of an update of the one or more software in a memory unit;
updating the one or more software that is the object of the update; and
not rebooting when only application is included in the one or more software that are the objects of the update;
rebooting with an initialization of hardware when software other than the application is included in the one or more software that are the objects of the update and when a kernel is included in the one or more software that are the objects of the update; and
rebooting without the initialization of the hardware when the kernel is not included in the one or more software that are the objects of an update.

7. A non-transitory storage medium on which is stored a computer program for making a computer execute a method for controlling an information processing apparatus that updates software, the method comprising:
determining whether or not only application is included in the objects of an update of the one or more software in a memory unit;
updating the one or more software that is the object of the update; and
not rebooting when only application is included in the one or more software that are the objects of the update;
rebooting with an initialization of hardware when software other than the application is included in the one or more software that are the objects of the update and when a kernel is included in the one or more software that are the objects of the update; and
rebooting without the initialization of the hardware when the kernel is not included in the one or more software that are the objects of an update.
